(19) United States
(12) Patent Application Publication
(10) Pub. No.: US 2025/0234863 A1
(43) Pub. Date: Jul. 24, 2025

(54) INSECT REPELLENT FOR USE ON HORSES

(71) Applicant: Andrea Krecklow, Wenzendorf (DE)

(72) Inventor: Ingo Krecklow, Wenzendorf (DE)

(21) Appl. No.: 18/855,500

(22) PCT Filed: Apr. 13, 2023
(86) PCT No.: PCT/DE2023/100273

§ 371 Date: Oct. 9, 2024

(30) Foreign Application Priority Data
Apr. 14, 2022 (DE) 10 2022 109 353.0

(51) Int. Cl. A01N 43/40; A01N 25/04; A01N 65/06; A01N 65/08; A01N 65/22; A01N 65/28; A01N 65/36; A01N 65/42; A01P 17/00

(52) U.S. Cl. CPC A01N 43/40; A01N 25/04; A01N 65/06; A01N 65/08; A01N 65/22; A01N 65/28; A01N 65/36; A01N 65/42; A01P 17/00

(57) ABSTRACT

A repellent for horses has a formulation which comprises at least the following: at least one emulsion base with a weight percentage between 1.0 wt. % and 5.0 wt. % relative to a unit amount of the formulation, at least one stabilizer based on acrylic acid with a weight percentage between 0.15 wt. % and 2.0 wt. % based on a unit amount of the formulation, at least one emulsifier with a weight percentage of between 0.1 wt. % and 2.0 wt. % based on a unit amount of the formulation, at least one piperidine-containing active ingredient with a weight percentage of between 10.0 wt. % and 30.0 wt. % based on a unit amount of the formulation, and water.

### CROSS-REFERENCE TO RELATED APPLICATIONS

This application is the US national phase of PCT/DE2023/100273, which was filed on Oct. 19, 2023 claiming the benefit of German Application No. 10 2022 109 353.0, filed on Apr. 14, 2022, which is incorporated herein by reference in its entirety.

### FIELD OF DISCLOSURE

The present disclosure relates to a repellent for horses.

### BACKGROUND

In principle, various insect repellent measures for horses are known, to keep biting flies, horseflies, or similar insects away from horses and thus spare them the stress caused by the insects and reduce possible disease risks. In addition to physical repellent measures, such as blankets or nets, chemical repellents are also known, with which the horses can be rubbed, such as powdery substances. However, since the application itself is time-consuming and laborious, sprayable substances are advantageous for the user.

For example, a sprayable repellent for horses is known from DE 10 2006 060 159 A1, which is based on garlic oil and has an insect-repellent effect. However, the repellent effect and the shelf life of the repellent are limited because garlic is not an active ingredient but only represents an odor masker. This can lead to an amount of the repellent losing its sprayability if it is stored improperly for a long time, for example if the repellent is not shifted during the winter months. This can render the respective amount of the repellent unusable.

Therefore, there is a need for repellent for horses that is more effective than known insect repellents. Preferably, the repellent should also have an extended shelf life.

The objective technical problem to be solved can be considered to consist in providing a repellent for horses that can eliminate or at least reduce the disadvantages of the prior art.

### SUMMARY

The problem is solved by the subject of the independent claim. Advantageous embodiments and aspects are indicated in the dependent claims and the following description, each of which may, alone or in (sub) combination, constitute aspects of the disclosure. All optional features may also be actual features of the disclosure, provided that the respective (sub) combination constitutes an advantageous further development.

According to one aspect, a repellent for horses is provided. The repellent has a formulation that includes at least:
at least one emulsion base with a weight percentage between 1.0 wt. % and 5.0 wt. % based on a unit amount of the formulation, preferably with a weight percentage between 1.5 wt. % and 4.0 wt. %, more preferably with a weight percentage between 2.0 wt. % and 3.0 wt. %, particularly preferably with a weight percentage of 2.34+0.10 wt. %, based in each case on a unit amount of the formulation,
at least one acrylic acid-based stabilizer with a weight percentage of between 0.05 wt. % and 2.0 wt. % based on a unit amount of the formulation, preferably with a weight percentage of between 0.10 wt. % and 1.0 wt. %, more preferably with a weight percentage between 0.15 wt. % and 0.50 wt. %, particularly preferably with a weight percentage of 0.18±0.05 wt. %, based in each case on a unit amount of the formulation,
at least one emulsifier with a weight percentage of between 0.01 wt. % and 2.0 wt. % based on a unit amount of the formulation, preferably with a weight percentage of between 0.05 wt. % and 1.0 wt. %, more preferably with a weight percentage between 0.10 wt. % and 0.50 wt. %, particularly preferably with a weight percentage of 0.13±0.05 wt. %, based in each case on a unit amount of the formulation,
at least one piperidine-containing active ingredient with a weight percentage of between 5.0 wt. % and 30.0 wt. % based on a unit amount of the formulation, preferably with a weight percentage of between 8.0 wt. % and 27.0 wt. %, more preferably with a weight percentage between 10.0 wt. % and 25.0 wt. %, particularly preferred with a weight percentage of 12.5±1.0 wt. % or 20.0±1.0 wt. %, each based on a unit amount of the formulation, and
water.

The piperidine-based active ingredient has a good repellent effect against insects, particularly with regard to biting flies, horseflies, biting and stinging mosquitoes, blackflies and ticks. For example, previously known repellents use garlic oil. However, garlic oil is only a fragrance. This means that garlic oil can to a certain extent mask the inherent odor of horses, which is mainly due to the specific carbon dioxide and protein exhalations of horses (so-called inherent odor maskers). In contrast, the piperidine-containing active ingredient is an active ingredient with a proven repellent effect. Compared to known insect repellent substances, the repellent is therefore more effective and has an increased duration of action of up to 8 hours.

Optionally, the piperidine-containing active ingredient can also be present with a weight percentage of between 12.5 wt. % and 30.0 wt. % based on a unit amount of the formulation, preferably also between 12.5 wt. % and 20.0 wt. %.

The unit amount is understood to be a particular defined quantity of the formulation, to which the relative proportions by weight of the individual components of the formulation given here relate, for example the unit amount may be 1000 g.

The acrylic acid-based stabilizer may be a substance sold under the trade name “Carbopol”, for example Carbopol 981, Carbopol 971, Carbopol 71G, Carbopol 974P, Carbopol 984, Carbopol 5984 or Carbopol 980. The substance sold under the trade name Carbopol 980 NF is particularly preferred for use as a stabilizer. In particular, the stabilizer may comprise a homopolymeric polyacrylic acid. The stabilizer is particularly adapted to ensure good mixing of the formulation.

The piperidine-containing active ingredient may be a substance sold under the trade name “Saltidin” or “Icaridin”. In particular, the piperidine-containing active ingredient may comprise 1-(1-methylpropoxycarbonyl)-2-(2-hydroxyethyl) piperidine.

Optionally, the formulation may comprise a liquid agent, preferably an emulsion.

In a particular embodiment, the formulation may additionally comprise a fragrance mixture with garlic oil and at least one other fragrance oil. This allows the odor of the formulation to be customized. In addition, garlic oil can mask the inherent odor of the horses and thus indirectly contributes to the insect repellency. Insect repellency can therefore be further improved, even though garlic oil is not an active ingredient.

The weight percentage of garlic oil can preferably be between 0.05 wt. % and 5.0 wt. %, more preferably between 0.08 wt. % and 3.0 wt. %, more preferably between 0.1 wt. % and 1.0 wt. %, more preferably between 0.15±0.05 wt. % and 0.30±0.05 wt. %, in each case based on a unit amount of the formulation. Some people find the scent of garlic unpleasant. The partial amounts selected here advantageously limit the intensity of the odor emanating from the garlic oil.

Alternatively or cumulatively, the fragrance mixture can additionally include at least one of lemon oil, clove oil, lavender oil, tea tree oil, cedar oil, eucalyptus oil, canola oil or a combination thereof. The additives mentioned make it possible to adjust the odor of the formulation as far as possible to suit requirements, so that the odor emanating from the formulation is perceived as pleasant.

Preferably, the emulsifier comprises at least polypropylene glycol-16 (PPG-16), capric acid and triglycerides or capric triglycerides. Thus, the emulsifier can preferably comprise medium-chain fatty acids. In particular, the emulsifier can be a substance sold under the trade name “ABIL Care”, for example “ABIL Care 85”.

Particularly preferably, the oil globules of the formulation, in particular of the emulsion, have a (mean) diameter of less than 3.0 μm, more preferably less than 2.0 μm, particularly preferably less than 1.6 μm. This ensures that the formulation can be sprayed. If the diameter is larger, the openings of the spray head may become blocked, at least over time. This problem is solved in the present case by the oil globules having correspondingly small diameters. For example, oil droplets can be broken up during the production of the formulation to avoid larger oil droplets in the formulation.

The small (mean) diameter of the oil globules also contributes to the long effectiveness (duration of action) of the formulation. The oil globules become coated with water molecules and the formulation ingredients dissolved in the water. The water molecules protect the oil globules from bursting, as they only burst when the coating of water molecules has evaporated (vaporized). After spraying the repellent onto the animal, an initial active phase begins in which the water molecules evaporate and the parts of the formulation that are attached to the water molecules or dissolved by the water content are released. The evaporation of the sprayed water leads to a drying out of the oil globules with regard to their wetting, so that the first active phase transitions into a second active phase in which the oil globules burst open. The oil globules then release the parts of the formulation dissolved in them. The transition from the first active phase to the second active phase can be seen as a gradual process.

When the water molecules evaporate during the first active phase, essentially the piperidine-containing active ingredient is released. The formulation therefore provides a good repellent effect against insects immediately after spraying. During the second phase of action, the oil components acting as fragrances are additionally used to mask the inherent odor of the animals. The gradual transition of the phases of action further improves the repellent effect against insects. Therefore, a long-lasting good repellent effect for a period of up to 8 hours can be guaranteed. It is not necessary to re-spray the repellent to achieve the repellent effect.

In a particular embodiment, the emulsifier comprises polypropylene glycol-16, based on a unit amount of the emulsifier, between 40.0 wt. % and 70.0 wt. %, more preferably between 45.0 wt. % and 60.0 wt. %, more preferably between 48.0 wt. % and 55.0 wt. %, particularly preferably 50.0±3.0 wt. %, based in each case on a unit amount of the emulsifier.

Advantageously, the weight percentage of a mixture of capric acid and triglycerides based on a unit amount of the emulsifier, is between 5.0% wt. % and 30.0 wt. %, preferably between 8.0 wt. % and 27.0 wt. %, more preferably between 10.0 wt. % and 25.0 wt. %, in each case based on a unit amount of the emulsifier.

The emulsifier formed in this way is particularly suitable for the present formulation.

Optionally, the formulation may further comprise sodium acetate with a weight percentage, based on a unit amount of the formulation, of between 0.001 wt. % and 1.00 wt. %, preferably between 0.01 wt. % and 0.50 wt. %, more preferably between 0.02 wt. % and 0.20 wt. %, more preferably between 0.03 wt. % and 0.10 wt. %, particularly preferably 0.04±0.01 wt. %, in each case based on a unit amount of the formulation. Sodium acetate is advantageous in preventing the aqueous components and the fatty portions of the formulation from separating from one another. This has the advantage of extending the shelf life of the formulation (emulsion). It results in a shelf life of up to 24 months. Despite such a long shelf life, the sprayability of the repellent is essentially retained.

In a preferred embodiment, the emulsion base comprises the following:
paraffin oil with a weight percentage based on a unit amount of the emulsion base, of between 75.0 wt. % and 90.0 wt. %, preferably between 77.0 wt. % and 85.0 wt. %, more preferably substantially 79.0±2.0 wt. %,
potassium oleate with a weight percentage based on a unit amount of the emulsion base, of 8.0 wt. % and 13.0 wt. %, preferably between 10.0 wt. % and 11.0 wt. %, more preferably essentially 10.4±0.2 wt. %, in each case based on a unit amount of the emulsion base,
n-pentanol with a weight percentage based on a unit amount of the emulsion base, of 2.0 wt. % and 5.0 wt. %, preferably between 3.0 wt. % and 4.0 wt. %, more preferably essentially 3.5±0.2 wt. %, in each case based on a unit amount of the emulsion base,
ethanol with a weight percentage based on a unit amount of the emulsion base, of 1.0 wt. % and 4.0 wt. %, preferably between 2.0 wt. % and 3.0 wt. %, more preferably essentially 2.5±0.2 wt. %, in each case based on a unit amount of the emulsion base,
ammonium oleate with a weight percentage based on a unit amount of the emulsion base, of 0.2 wt. % and 1.0 wt. %, preferably between 0.5 wt. % and 0.8 wt. %, more preferably substantially 0.7±0.1 wt. %, in each case based on a unit amount of the emulsion base,
anise oil with a weight percentage based on a unit amount of the emulsion base, of 0.5 wt. % and 2.5 wt. %, preferably between 1.0 wt. % and 2.0 wt. %, more preferably substantially 1.3±0.1 wt. %, in each case based on a unit amount of the emulsion base,
peppermint oil with a weight percentage based on a unit amount of the emulsion base, of 0.5 wt. % and 2.5 wt. %, preferably between 1.0 wt. % and 2.0 wt. %, more preferably substantially 1.3±0.1 wt. %, in each case based on a unit amount of the emulsion base, and
rice oil with a weight percentage based on a unit amount of the emulsion base, of 0.5 wt. % and 2.5 wt. %, preferably between 1.0 wt. % and 2.0 wt. %, more preferably substantially 1.3±0.1 wt. %, in each case based on a unit amount of the emulsion base.

The total of the respective substance proportions is always 100 wt. % of the emulsion base. The emulsion base acts as a thickener. It increases the viscosity of the formulation. It can also enhance or strengthen the effect of the stabilizer (carobopol).

The emulsion base can also have a different composition than the one mentioned above. What is important is that it ensures an increase in viscosity.

The paraffin oil of the emulsion base can have a density between 0.827 and 0.890 g/cm3 and a viscosity between 110-230 mPa·s.

The emulsion base formed in this way has proven to be particularly suitable for combining a long shelf life and high effectiveness of the repellent.

The formulation is advantageously produced by mixing the individual components with each other over a period of between 2 hours and 5 hours, preferably between 2 hours and 3 hours. A temperature between 25° C. and 35° C. is maintained, at least for a period of between 1 hour and 2 hours, preferably between 1 hour and 3 hours, of the mixing process.

During production, the oil droplets are preferably broken up into oil globules in such a way that the oil globules have a (mean) diameter of less than 3.0 μm, preferably less than 2.0 μm, more preferably less than 1.6 μm. This ensures that the formulation can be sprayed well.

The disclosure further relates to the use of the repellent for the protection of dogs against insects, in particular ticks, biting flies, horse flies, stinging and biting mosquitoes, and blackflies.

Each of the above aspects can be combined with any other aspect, provided that the skilled person has access to reasonably conceivable developments.

The above aspects and further advantages of the claimed subject matter will be more readily understood when illustrated by reference to the following detailed embodiments.

### DETAILED DESCRIPTION

The detailed description of the embodiments below is intended as a description of various embodiments of the disclosed subject matter and is not intended to represent the only embodiments. Each embodiment described in this disclosure is intended only as an example and should not be interpreted as preferred or advantageous over other embodiments. The examples contained herein do not claim completeness and do not limit the claimed subject matter to the exact forms disclosed. Various modifications to the described embodiments will be readily apparent to those skilled in the art, and the general principles defined herein can be applied to other embodiments and applications without departing from the scope of the described embodiments. Therefore, the described embodiments are not limited to the shown embodiments, but rather have the broadest scope consistent with the principles and features disclosed herein.

All features of the disclosure examples disclosed below may be combined, alone or in any sub-combination, with features of aspects of the present disclosure, including features of preferred embodiments thereof, provided that the resulting combination of features is meaningful to a person skilled in the art.

For example, for purposes of the present disclosure, the phrase “at least one of A, B, and C” means (A), (B), (C), (A and B), (A and C), (B and C), or (A, B, and C), including all other possible combinations when more than three items are listed. In other words, the term “at least one of A and B” generally means “A and/or B”, namely “A” alone, “B” alone or “A and B”.

The following table shows four different embodiments A. B. C. and D of the repellent.

TABLE 1
Various embodiments A, B, C, and D of the
repellent with relative weight information.

| Ingredient | A | B | C | D |
|---|---|---|---|---|
| Emulsion base | 2.34% (F) | 2.34% (F) | 2.34% (F) | 2.34% (F) |
| Paraffin oil (E) | 79% (E) | 79% (E) | 79% (E) | 79% (E) |
| Potassium | 10.4% (E) | 10.4% (E) | 10.4% (E) | 10.4% (E) |
| oleate (E) | | | | |
| n-pentanol (E) | 3.5% (E) | 3.5% (E) | 3.5% (E) | 3.5% (E) |
| Ethanol (E) | 2.5% (E) | 2.5% (E) | 2.5% (E) | 2.5% (E) |
| Ammonium | 0.7% (E) | 0.7% (E) | 0.7% (E) | 0.7% (E) |
| oleate (E) | | | | |
| Anise oil (E) | 1.3% (E) | 1.3% (E) | 1.3% (E) | 1.3% (E) |
| Peppermint | 1.3% (E) | 1.3% (E) | 1.3% (E) | 1.3% (E) |
| oil (E) | | | | |
| Rice oil (E) | 1.3% (E) | 1.3% (E) | 1.3% (E) | 1.3% (E) |
| Lemon oil (D) | 0.45% (F) | 0.45% (F) | 0.45% (F) | 0.00% |
| Clove oil (D) | 0.45% (F) | 0.45% (F) | 0.45% (F) | 0.00% |
| Garlic oil (D) | 0.00% | 0.30% (F) | 0.15% (F) | 0.00% |
| Lavender oil (D) | 0.45% (F) | 0.45% (F) | 0.45% (F) | 0.00% |
| Tea tree oil (D) | 0.45% (F) | 0.45% (F) | 0.45% (F) | 0.00% |
| Cedar oil (D) | 0.45% (F) | 0.45% (F) | 0.45% (F) | 0.00% |
| Eucalyptus oil (D) | 0.38% (F) | 0.38% (F) | 0.38% (F) | 0.00% |
| Sodium acetate (V) | 0.04% (F) | 0.04% (F) | 0.04% (F) | 0.04% (F) |
| Vinegar (H) | 0.19% (F) | 0.19% (F) | 0.19% (F) | 0.19% (F) |
| Canola oil (D) | 2.50% (F) | 2.50% (F) | 2.50% (F) | 2.50% (F) |
| Carbopol (S) | 0.18% (F) | 0.18% (F) | 0.18% (F) | 0.18% (F) |
| ABILCare (EM) | 0.13% (F) | 0.13% (F) | 0.13% (F) | 0.13% (F) |
| Saltidin (W) | 12.5% (F) | 12.5% (F) | 12.5% (F) | 20% (F) |
| Water (onto 100%) | 79.49% (F) | 79.19% (F) | 79.34% (F) | 74.62% (F) |
| Total | 100.00% | 100.00% | 100.00% | 100.00% |

In Table 1, (E) denotes emulsion base, (F) denotes formulation, (D) denotes fragrance, (V) denotes connecting excipient, (H) denotes excipient, (S) denotes stabilizer, (EM) denotes emulsifier, and (W) denotes active ingredient. In the respective weight proportions, (F) means that the respective weight proportion refers to a unit amount of the formulation, whereas (E) means that the respective weight proportion refers to a unit amount of the emulsion base. This means that the relative proportions (E) of the emulsion base together add up to 100%. The relative proportions (F) of the formulation also add up to 100%.

All weight percentages in Table 1 are to be assessed with an error limit of 0.1 wt. %, provided that the respective weight percentage is 2.0 wt. % or less, with an error limit of 0.2 wt. %, provided that the respective weight percentage is greater than 2.0 wt. % and less than 10 wt. %, and otherwise with an error limit of 1.5 wt. %. The water content may vary accordingly for the purpose of adjustment. Naturally, the error cannot cause a weight percentage to be less than zero.

As can be seen from Table 1, the embodiments A, B, and C differ with regard to the proportion of garlic oil. While embodiment A has no garlic oil and is therefore well compatible with users who find the smell of garlic unpleasant, embodiment B has an increased proportion of garlic oil. Embodiment C has a proportion of garlic oil that lies between those of embodiments A and B. The garlic oil can further increase the repellent effect against insects. Nevertheless, all three embodiments comprise the piperidine-containing active ingredient “Saltidin”, so that effectiveness is guaranteed in any case, independently of the garlic oil.

Embodiment D represents a special formulation without any fragrances, but with an increased proportion of the active ingredient. Embodiment D is therefore particularly suitable when there is heavy insect infestation, for example due to special climatic conditions or when users want an odorless repellent.

Embodiment A of the repellent can in particular essentially comprise at least the following:
at least one paraffin oil-containing emulsion base with a weight percentage between 1.0 wt. % and 5.0 wt. % based on a unit amount of the formulation,
at least one acrylic acid-based stabilizer with a weight percentage of between 0.05 wt. % and 2.0 wt. % based on a unit amount of the formulation,
at least one emulsifier with a weight percentage of between 0.01 wt. % and 2.0 wt. % based on a unit amount of the formulation,
at least one piperidine-containing active ingredient with a weight of between 10.0 wt. % and 15.0 wt. % based on a unit amount of the formulation, and
water.

Embodiment B of the repellent may in particular essentially comprise at least the following:
at least one paraffin oil-containing emulsion base, with a weight percentage of between 1.0 wt. % and 5.0 wt. % based on a unit amount of the formulation,
at least one acrylic acid-based stabilizer, with a weight percentage of between 0.05 wt. % and 2.0 wt. % based on a unit amount of the formulation,
at least one emulsifier with a weight percentage of between 0.01 wt. % and 2.0 wt. % based on a unit amount of the formulation,
at least one piperidine-containing active principle with a weight percentage of between 10.0 wt. % and 15.0 wt. % based on a unit amount of the formulation,
garlic oil with a weight percentage of between 0.20 wt. % and 0.40 wt. %, and
water.

Embodiment C of the repellent may in particular comprise essentially at least:
at least one paraffin oil-containing emulsion base with a weight percentage of between 1.0 wt. % and 5.0 wt. % based on a unit amount of the formulation,
at least one acrylic acid-based stabilizer with a weight percentage between 0.05 wt. % and 2.0 wt. % based on a unit amount of the formulation,
at least one emulsifier with a weight percentage between 0.01 wt. % and 2.0 wt. % based on a unit amount of the formulation,
at least one piperidine-containing active ingredient with a weight percentage of between 10.0 wt. % and 15.0 wt. % based on a unit amount of the formulation,
garlic oil with a weight percentage of between 0.10 wt. % and 0.20 wt. %, and
water.

Optionally, the embodiments A, B and C may comprise further additives, for example fragrances.

The embodiment D of the repellent may in particular essentially comprise at least the following:
at least one paraffin oil-containing emulsion base with a weight percentage between 1.0 wt. % and 5.0 wt. % based on a unit amount of the formulation,
at least one acrylic acid-based stabilizer with a weight percentage of between 0.05 wt. % and 2.0 wt. % based on a unit amount of the formulation,
at least one emulsifier with a weight percentage of between 0.01 wt. % and 2.0 wt. % based on a unit amount of the formulation,
at least one piperidine-containing active ingredient with a weight percentage of between 15.0 wt. % and 25.0 wt. % based on a unit amount of the formulation, and
water.

In a particular embodiment, embodiment D can also include further additives, optionally also further fragrances mentioned herein.

All embodiments of the repellent show a strong repellent effect against insects of the species mentioned. The insect infestation was determined for horses that were sprayed with the repellent and for a comparison group that was left without repellent. The comparison groups were otherwise exposed to the same conditions. After spraying, the insect infestation was measured and determined by counting for the following periods, in particular for the following 8 hours. The sprayed horses had significantly less insect infestation than the control group. The efficacy study was repeated several times. Different horse breeds and seasons (climatic conditions) were taken into account in the efficacy study. As expected, the repellent according to Embodiment D shows even better efficacy than the repellent of Embodiments A, B, and C.

In the present application, reference may be made to quantities and numbers. Unless explicitly stated, such quantities and numbers are not to be considered limiting, but rather as examples of the possible quantities or numbers in the context of the present application. In this context, the term “plural” may also be used in the present application to refer to a quantity or number. In this context, the term “plurality” refers to any number greater than one, e.g., two, three, four, five, etc. The terms “about,” “approximately,” “near,” etc., mean plus or minus 5% of the stated value.

Although the disclosure is illustrated and described with reference to one or more embodiments, other skilled persons will recognize when reading and understanding this description equivalent changes and modifications. Also, although a particular feature of the disclosure has been disclosed only in relation to one of a plurality of embodiments, such feature may be combined with one or more other features of the other embodiments as may be desirable and advantageous for a given or particular application.

1. A repellent for horses comprising a formulation that includes at least:
A) at least one emulsion base with a weight percentage between 1.0 wt. % and 5.0 wt. % based on a unit amount of the formulation,
B) at least one acrylic acid-based stabilizer with a weight percentage of between 0.05 wt. % and 2.0 wt. % based on a unit amount of the formulation,
C) at least one emulsifier with a weight percentage of between 0.01 wt. % and 2.0 wt. % based on a unit amount of the formulation,
D) at least one piperidine-containing active ingredient with a weight percentage of between 5.0 wt. % and 30.0 wt. % based on a unit amount of the formulation, and
E) water.

2. The repellent for horses according to claim 1, wherein the formulation additionally comprises a fragrance mixture, the fragrance mixture comprising garlic oil and at least one other fragrance oil.

3. The repellent for horses according to claim 2, wherein the weight percentage of the garlic oil, based on a unit amount of the formulation, is between 0.05 wt. % and 5.0 wt. %.

4. The repellent for horses according to claim 3, wherein the weight percentage of the garlic oil, based on a unit amount of the formulation, is between 0.15 wt. % and 0.3 wt. %.

5. The repellent for horses according to claim 2, wherein the fragrance mixture additionally comprises at least one of lemon oil, clove oil, lavender oil, tea tree oil, cedar oil, eucalyptus oil, canola oil, or a combination thereof.

6. The repellent for horses according to claim 1, wherein the weight percentage of the piperidine-containing active ingredient, based on a unit amount of the formulation, is between 12.5 wt. % and 22.5 wt. %.

7. The repellent for horses according to claim 1, wherein the emulsifier comprises at least polypropylene glycol-16, capric acid and triglycerides.

8. The repellent for horses according to claim 7, wherein a weight percentage of polypropylene glycol-16, based on a unit amount of the emulsifier, is between 50.0 wt. % and 80.0 wt. %, and in that a weight percentage of a mixture of capric acid and triglycerides, based on a unit amount of the emulsifier, is between 10.0 wt. % and 20.0 wt. %.

9. The repellent for horses according to claim 1, wherein the formulation additionally comprises sodium acetate with a weight percentage, based on a unit amount of the formulation, of between 0.02 wt. % and 1.00 wt. %.

10. The repellent for horses according to claim 1, wherein the emulsion base comprises the following:
A1) paraffin oil with a weight percentage, based on a unit amount of the emulsion base, of between 75.0 wt. % and 80.0 wt. %,
A2) potassium oleate with a weight percentage, based on a unit amount of the emulsion base, of 10.0 wt. % and 11.0 wt. %,
A3) n-pentanol with a weight percentage based on a unit amount of the emulsion base of 3.0 wt. % and 4.0 wt. %,
A4) ethanol with a weight percentage based on a unit amount of the emulsion base of 2.0 wt. % and 3.0 wt. %,
A5) ammonium oleate with a weight percentage based on a unit amount of the emulsion base of 0.2 wt. % and 1.0 wt. %,
A6) anise oil with a weight percentage based on a unit amount of the emulsion base of 1.0 wt. % and 2.0 wt. %,
A7) peppermint oil with a weight percentage, based on a unit amount of the emulsion base, of 1.0 wt. % and 2.0 wt. %, and
A8) rice oil with a weight percentage, based on a unit amount of the emulsion base, of 1.0 wt. % and 2.0 wt. %.
